(19) United States
(12) Patent Application Publication
(10) Pub. No.: US 2002/0121775 A1
(43) Pub. Date: Sep. 5, 2002

(54) Expandable scrapbooking organizer

(76) Inventor: Marietta V. Sperry, Simi Valley, CA (US)

Correspondence Address: THORPE NORTH WESTERN, 8180 SOUTH 700 EAST, SUITE 200, P.O. BOX 1219, SANDY, UT, 84070, US

(21) Appl. No.: 10/066,392

(22) Filed: Jan. 30, 2002

Related U.S. Application Data
(60) Provisional application No. 60/265,382, filed on Jan. 30, 2001.

(51) Int. Cl. B42D 1/08; B42F 5/00

(52) U.S. Cl. 281/22

(57) ABSTRACT

A system for organizing and storing scrapbooking material that is convenient and relatively compact can include an organizer having one or more translucent or transparent wall(s), and one or more pocket(s) configured to conveniently hold 12″×12″ sheets; and wherein the organizer can comprise additional pockets of different sizes, whereby at least some contents of the organizer can be visually discerned when the organizer is in a closed position.

This application claims the benefit of U.S. Provisional Application No. 60/265,382 filed Jan. 30, 2001.

### FIELD OF THE INVENTION

The present invention is related to systems for the storage and organization of materials used for scrapbook creation, more specifically, it is related to an apparatus and a method for organizing art media materials, content, mementos and art supplies used in the creation of scrapbooks, such that more convenient accessible use of the materials, supplies, etc., can be realized.

### BACKGROUND OF THE INVENTION

Many expandable organizers have been created, for example, for providing an organization aid for documents and computer media either separately or in combination. Typically, such organizers are sized specifically for legal sized or standard sized documents. Specifically, there is a type of expanding file which is made of panels of heavy paper, cardstock, fiber board or the like, having accordion-fold sides. A space infused between the panels defines a document folder such that a document can be received in the document folder from the top. Other materials have also been used to make such organizers including plastics. Organizers having pockets for computer disks are also known. An example can be found in the disclosure of U.S. Pat. No. 5,275,438. That reference discloses a file folder with an attached computer disk pocket and a retaining flap to prevent the loss of a disk contained therein. There, the walls of the file and the pocket can be made from translucent plastic to allow easy viewing of the file folder contents.

File folders and organizers specifically adapted to organizing materials for scrapbooking will need features not typically found in prior file folders and organizers. Prior devices of this kind were developed with different purposes in mind. Scrapbooks have been developed over the years which allow persons to arrange and store collectable items for convenient viewing. For example, some scrapbooks have included pages upon which photographs can be attached. Other scrapbooks have provided other features, such as pockets for storing items that a person may wish to later take out and examine. In more recent years, great interest has developed in customizing scrapbooks using art paper, stickers, die cut shapes, and the like. Thus, customized scrapbook pages can be created that are specific to certain events; and artistic and ornamental elements can be incorporated which enhance the presentations of the subject matter which the scrapbook page is intended to communicate or commemorate.

The hobby of customizing scrapbooks, or scrapbooking, can require a variety of supplies. Organization of such supplies has often required different storage devices or methods, some of which are inconvenient, or at least not ideal for such users, or “scrapbookers.” For example, a scrapbooker typically needs to store, and have easy access to, many items including specialty paper of odd size, small stickers, floppy disks and/or compact disks containing clipart, die cuts, glues, tapes, acid free plastic cover sheets and photo corners, photographs, etc. Usually the scrapbooker has turned to file folders and organizers made for entirely different purposes. For example, expanding legal or letter size file folders can be used such as those mentioned above, and others made for other purposes, but these do not usually conveniently accommodate 12″×12″ paper, a standard size used in scrapbooking, so as to protect it from damage and make it readily available. This is just one example illustrating a need specific to scrapbooking.

Such prior files and organizers are typically made of opaque materials. Pockets tend to be dark, and small cut-outs, or pieces of a particular desired color, may be difficult to find in such organizers. The contents may need to be removed to be identified. For these and other reasons scrapbookers in the past have typically used several types of containers and organizers/file folders to store and organize scrapbooking supplies, mostly designed for other purposes.

### SUMMARY OF THE INVENTION

It has been recognized that it would be advantageous to develop a scrapbooking organizer that is convenient to use, provides for light infusion and enhanced visibility of its contents, and is sized to accommodate standard scrapbooking materials, including 12″×12″ sheets. In accordance with the invention an expandable scrapbooking organizer is provided having a closed position and an expanded position, wherein the organizer has a plurality of first expanding pockets configured for holding and protecting 12″×12″ sheets in an unfolded condition when the organizer is in the closed position. The organizer is at least particularly translucent and configured such that when the organizer is in the closed position, at least a color aspect of the contents can be perceived through a wall of the organizer.

In a more detailed aspect, the first pocket can be defined by walls configured for holding and organizing various contents, wherein the walls comprise a material that is archival safe. Such a material can include polypropylene. Further, the contents can be viewed through a wall of the organizer if at least one wall of a pocket is either transparent or translucent.

The organizer can comprise a second pocket of a different size than the plurality of first expanding pockets. The second pocket can be configured such that contents of the second pocket can be seen when the organizer is in a closed position. Such a pocket can be, for example, configured to hold data storage media, such as an optical disk or floppy disk, flash memory card, etc., or cutouts, stickers, etc.

The organizer can also comprise a third pocket of a different size than the plurality of first expanding pockets and the second pocket. The third pocket can be configured such that its contents can be seen when the organizer is in the closed position. Such a pocket can be, for example, configured to also hold a disk or cut shapes, stickers, etc. The organizer can be configured such that the pockets are defined by walls that are translucent or otherwise see-through. This allows light into the pockets so the contents can be better seen when a user is looking in from the top of the pocket, and allows the contents of the pockets to be at least partially discernable when the pockets are closed.

In accordance with the present invention, an expandable scrapbooking organizer can have a first pocket configured for holding and protecting 12″×12″ inch paper in an unfolded condition, and can have a second pocket of a different size than the first pocket; and can have a third pocket of a different size than the first pocket and the second pocket. Each of pockets can be defined by at least one pocket wall that is see-through. In another more detailed aspect, all of the pockets can be defined entirely by walls that are see-through. Using either arrangement, the second pocket and/or the third pocket can be configured to allow the contents to be seen when the organizer is in a closed position. These pockets can be configured to snugly accommodate specific sized items such as die-cut shapes, stickers, and other artistic and ornamental supplies, floppy disks, optical disks, zip disks, flash memory cards, or other items that would be useful when scrapbooking.

A method for organizing scrapbooking materials can comprise providing an expandable organizer having a multiplicity of pockets configured for holding scrapbooking materials, wherein the pockets are configured such that at least one pocket can hold and protect a 12″×12″ paper in an unfolded condition, and wherein the organizer is further configured such that when paper is within the at least one pocket, it can be perceived through a wall of the organizer; assigning individual pockets specific categories for holding scrapbooking materials having a commonality within a category; and placing the scrapbooking material into the individual pockets based upon the assigned category commonality. Such commonality can be based upon size or shape, color, texture of the scrapbooking material, or the intended use of the scrapbooking material, for example.

### BRIEF DESCRIPTION OF THE FIGURES

In the accompanying drawings which illustrate embodiments of the invention:

FIG. 1 is a perspective view of an expandable organizer in a closed position;

FIG. 2 is a perspective view of an expandable organizer in an open and expanded position;

FIG. 3 is a front view of an expandable organizer in an open and non-expanded position;

FIG. 4 is a front view of an expandable organizer in a closed position;

FIG. 5 is a back view of an expandable organizer in a closed position; and

FIG. 6 is a partial cutaway perspective view of an expandable organizer in an open and expanded position.

### DETAILED DESCRIPTION OF THE PREFERRED EMBODIMENT(S)

Particular exemplary embodiments of the invention will now be described. It is to be understood that the invention is not limited to the particular configurations, process steps and materials disclosed herein. It is also to be understood that the examples and the terminology used herein are selected for the purpose of illustrating and describing particular embodiments only, and is not intended to be limiting of the scope of the invention. It will be understood that the defined invention to which protection by letters patent is sought will be defined only by the appended claims and equivalents thereof. Reference will be made to the exemplary embodiment(s) described herein and illustrated in the drawings, and specific language will be used herein to describe the same. Alterations and further modifications of the inventive features, and additional applications of the principles of the invention as illustrated herein, which would occur to one skilled in the relevant art and having possession of this disclosure, are to be considered within the scope of the invention.

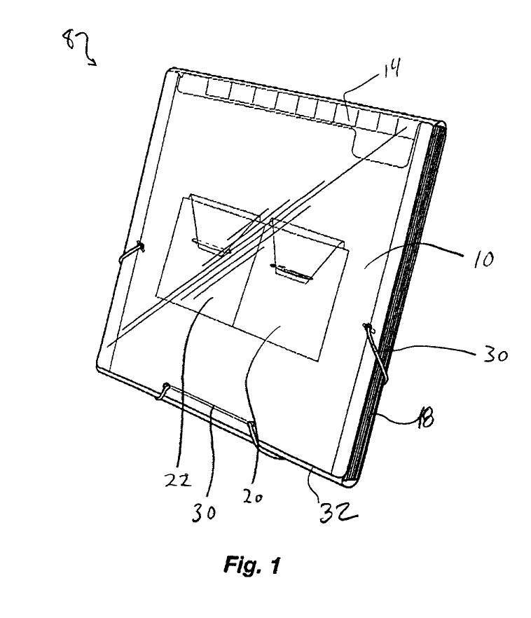

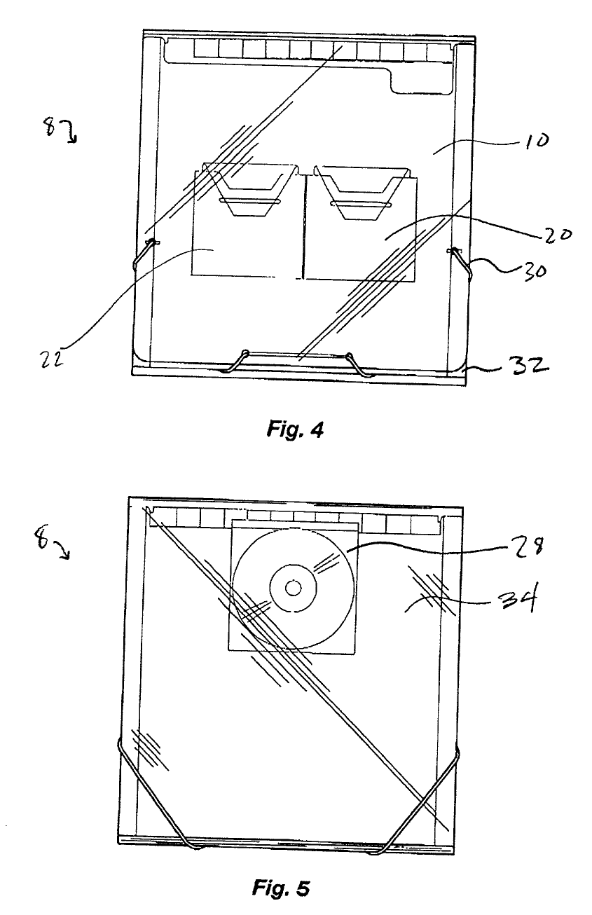

As illustrated in the figures, and with particular reference to FIG. 1 and FIG. 4., a scrapbooking organizer system, comprising an organizer indicated generally at 8, in accordance with an embodiment of the present invention, is shown in a closed position; and is configured for organizing and storing scrapbooking materials. As can be seen, a cover 10 is closed over a front wall 32 of the organizer such that envelope-like pocket structures 20,22 carried by the front wall are protected. In this embodiment, the cover 10 and the envelope-like structures 20,22 are clear plastic so that the envelope-like structures 20,22 and their contents can be seen through the cover. An elastic fastener 30 is used to hold the cover 10 shut. The cover 10 and the elastic fastener 30 work in concert to prevent the expandable organizer from opening and contents from coming out until the elastic fastener 30 is disengaged and the cover 10 is retracted backwards to an open position. Though an elastic fastener 30 is shown, another fastener that holds the cover 10 in place against the expandable portion of the organizer can be used, e.g., a snap, a VELCRO® closure, a magnet closure, etc. Tabs 14 are also provided for easy identification and access to individual pockets.

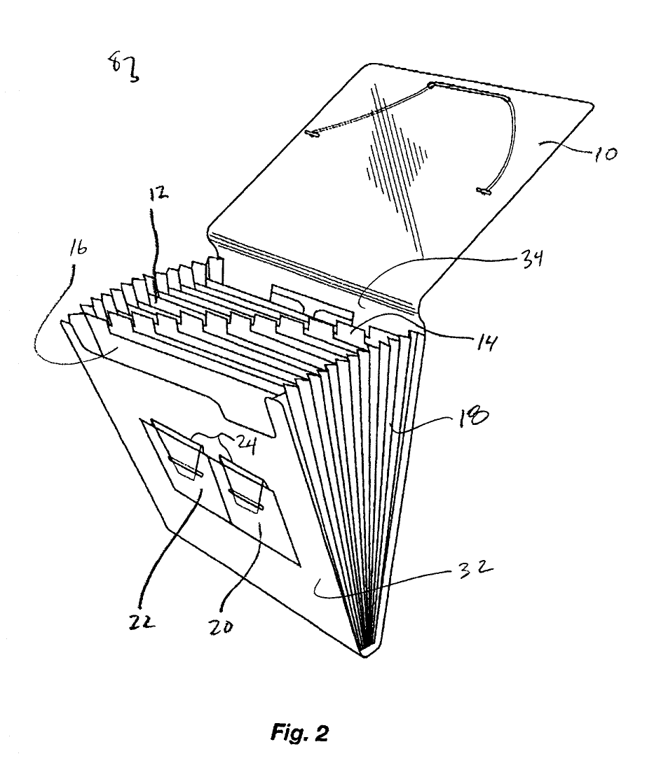

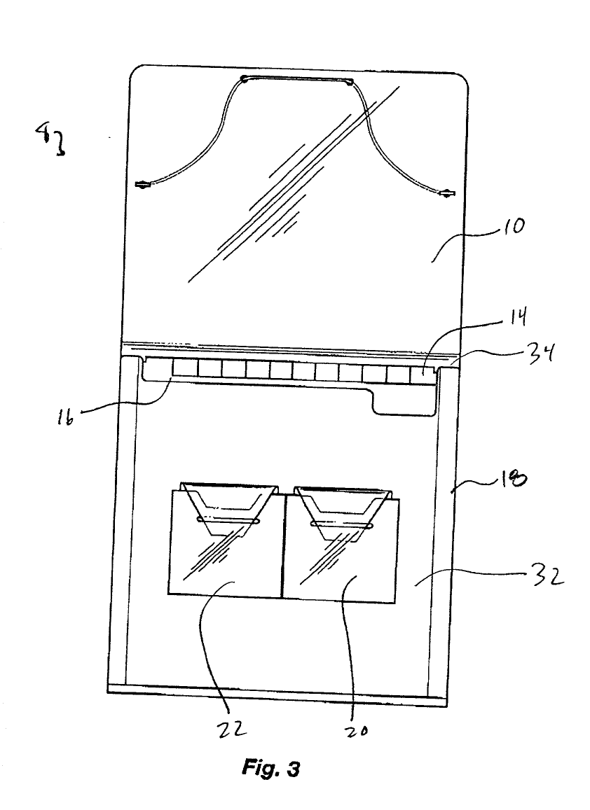

Turning now to FIG. 2 and FIG. 3, the organizer 8 is shown in an open position wherein the cover flap 10 is folded back such that individual pockets 12 are exposed. This allows access to the individual products, and the separately closable pocket structures 20, 20. The individual pockets 12 comprise as series of pockets configured in an accordion-like file configuration. They are configured to accommodate at least 12″×12″ sheets. Tabs 14 are present at the top of pocket walls 16. The pocket walls are attached to accordion-fold side walls 18. The configuration allows expansion of the pockets. The tabs 14 are configured to accept labels (not shown), which can identify categories of materials to be placed in individual pockets, or can comprise other indicia, such as colors, letters, numbers, or months of the year, to name a few examples. The front wall 32 of the foremost pocket 18 carries the pair of small or separately closable pockets. The envelope-like enclosures 20,22 can be used to hold small items such as die-cut shapes, floppy disks, and/or stickers (not shown), for example. Because the entire folder can be constructed of clear or semi-clear plastic material, one can more easily see what is in the pockets 12 or envelope-like structures 20,22. In one embodiment, the entire structure can be constructed of a clear plastic material. In another embodiment, at least a portion of the front wall 32, and/or a back wall 34, and pocket walls 16, and the sidewalls 18 and cover flap 10 be see-though, e.g., transparent or translucent.

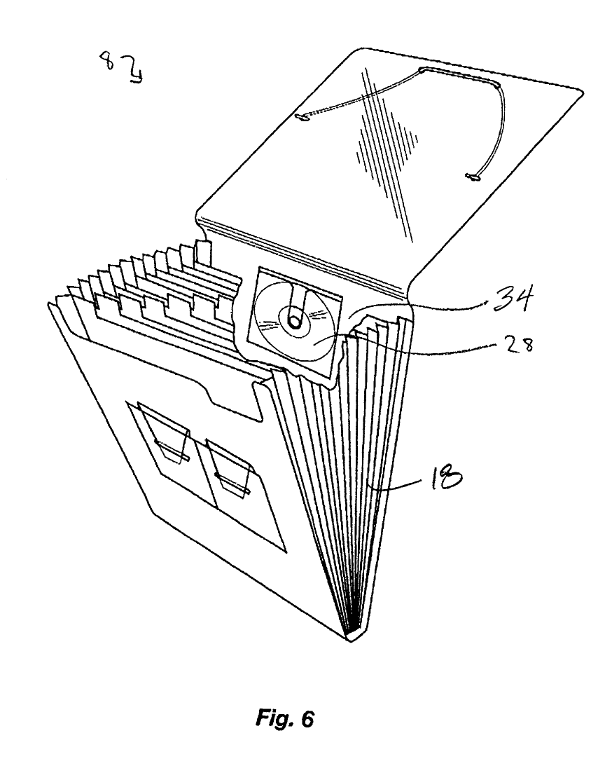

Referring to FIG. 5 and FIG. 6, an organizer 8 of the system 8 can comprise a third pocket 28. In the illustrated embodiment, the organizer is configured to allow the third pocket to be seen through the back wall 34 when the organizer is either in an open or a closed position. Additionally, the third pocket can be configured to snugly hold data storage media, such as an optical disk (CD, CD-R, CD-RW, DVD, CD-ROM, or the like) or other devices.

In the illustrated embodiment, the expandable organizer is configured specifically for organizing scrapbooking materials. For example, each of the pockets is configured to conveniently hold square 12″×12″ papers and pages. A 13″×13″ pocket provides one preferred size for scrapbook paper organization.

With most filing systems, opaque materials are typically used because privacy is required. With the expandable organizer 8 of an embodiment of the present invention, no such privacy is required. The see-through material can be color-tinted, but still “see-through”. This allows a scrapbooker to maintain a plurality of organizers in a system, and readily distinguish them. Tinting can simply accommodate an aesthetic preference of a user. Moreover, whether tinted or not, the plastic can be “clear” so that small text can be read through it, or, in another embodiment it can be “frosted” so that the color, pattern, or large text can be discerned through it, but fine detail cannot.

In the illustrated embodiment separately closable pockets comprising envelope-like structures 20,22 can be attached to the front wall 32 of the organizer (under the cover flap 10 when closed). As mentioned, these can be sized and configured for holding small items such as stickers and die cut shapes. Floppy disks containing clipart or other scrapbook materials can also be held in appropriately configured envelope-like structures such as these. Closure can be by means of flaps 24 that fold into slots 26 to hold them closed. Other closures, such as VELCRO® snaps or magnets can be used. On the inside of the back-most pocket 12, a separate pocket 28 appropriate for holding an optical disk can be attached to a rear wall 34 of the organizer. Another pocket configuration from that shown can also be used for this function, and it can be provided with a separate closure like the other pockets 20,22. Alternatively, an optical disk holder pocket can be placed on an exterior surface such as on the outside of the foremost surface of the front wall 32, adjacent the other pockets. Having such a feature present is desirable because compact disks containing clipart, or containing music to listen to during the scrapbooking process, are often desired.

The present invention has been shown in the drawings and fully described above with particularity, and detail in connection with what is presently deemed to be the most practical and preferred embodiment(s) of the invention. However, it will be apparent to those of ordinary skill in the art that numerous modifications can be made without departing from the principles and concepts within the scope of the invention as set forth in the claims and all equivalents thereof.

It will also be apparent that the above-described embodiments of the invention provide a system for convenient organization and access to scrapbooking materials in a simple and low-cost way. The organizer 8 can conveniently protect standard 12″×12″ scrapbooking sheets, and provide the other advantages using known low-cost manufacturing methods.

What is claimed is:

1. An expandable scrapbooking organizer having a closed position and an expanded position, said organizer having a plurality of first expanding pockets configured for holding and protecting 12″×12″ sheets in an unfolded condition when the organizer is in the closed position, and wherein said organizer is configured such that at least a color aspect of contents of the organizer can be visually appreciated through a wall of the organizer.

2. An expandable scrapbooking organizer as in claim 1, comprising walls configured for holding and organizing contents, said walls comprising a material that is archival safe.

3. An expandable scrapbooking organizer as in claim 2, wherein the material is polypropylene.

4. An expandable scrapbooking organizer as in claim 1, wherein the wall is transparent.

5. An expandable scrapbooking organizer as in claim 1, wherein the wall is translucent.

6. An expandable scrapbooking organizer as in claim 1, further comprising a second pocket of a different size than the plurality of first expanding pockets, and wherein the second pocket is configured such that at least a color aspect of contents of the second pocket can be visually appreciated through a wall of the organizer.

7. An expandable scrapbooking organizer as in claim 6, wherein the second pocket is configured to hold data storage media.

8. An expandable scrapbooking organizer as in claim 6, further comprising a third pocket of a different size than the plurality of first expanding pockets and the second pocket, and wherein the third pocket is configured such that contents of the third pocket can be visually appreciated through a wall of the organizer.

9. An expandable scrapbooking organizer as in claim 6, wherein the second pocket is configured to hold one of an optical disk and a magnetic data storage disk.

10. An expandable scrapbooking organizer as in claim 1, wherein each of the pockets is defined by at least one wall that is see-through.

11. An expandable scrapbooking organizer having a first expanding pocket configured for holding and protecting 12″×12″ paper in an unfolded condition,
a second pocket of a different size than the first pocket; and
a third pocket of a different size than the first expanding pocket and the second pocket, each of said pockets being defined by at least one pocket wall that is see-through.

12. An expandable scrapbooking organizer as in claim 11, wherein each of the pockets is defined by a plurality of walls that are see-through.

13. An expandable scrapbooking organizer as in claim 11, wherein the second pocket is configured to be seen when the organizer is in a closed position.

14. An expandable scrapbooking organizer as in claim 11, wherein the second pocket is configured to hold data storage media.

15. An expandable scrapbooking organizer as in claim 11, wherein the third pocket is configured to be seen when the organizer is in a closed position.

16. An expandable scrapbooking organizer as in claim 15, wherein the third pocket is configured to hold data storage media.

17. An organizer as in claim 11, wherein the wall that is see-through is clear.

18. An organizer as in claim 11, wherein the wall is translucent.

19. An organizer as in claim 11, wherein the wall is color-tinted.

20. A method for organizing scrapbooking materials, comprising:
providing an expandable organizer having a multiplicity of pockets configured for holding scrapbooking materials, said multiplicity of pockets being configured such that at least one of said pockets is configured for holding and protecting 12″×12″ paper sheets in an unfolded condition, wherein said organizer is further configured such that when one of such paper sheets is within said at least one pocket, and wherein at least a color aspect of contents can be visually appreciated through a wall of the organizer;
assigning individual pockets of the multiplicity of pockets specific categories for holding scrapbooking materials having a commonality; and
placing scrapbooking materials into individual pockets based upon the commonality.

21. A method as in claim 20, wherein the commonality is based upon one of the size, use, color, and texture of the scrapbooking material.
